(19) United States
(12) Patent Application Publication
(10) Pub. No.: US 2010/0031488 A1
(43) Pub. Date: Feb. 11, 2010

(54) REPLACING TUBES IN AIR TREATMENT SYSTEMS

(76) Inventors: Scott Steven Krell, Phoenix, AZ (US); Alf Mauritzon, Scottsdale, AZ (US)

Correspondence Address: SQUIRE SANDERS & DEMPSEY LLP, TWO RENAISSANCE SQUARE, 40 NORTH CENTRAL AVENUE, SUITE 2700, PHOENIX, AZ, 85004-4498, US

(21) Appl. No.: 12/358,127

(22) Filed: Jan. 22, 2009

Related U.S. Application Data
(60) Provisional application No. 61/022,815, filed on Jan. 22, 2008.
(60) Provisional application No. 61/119,654, filed on Dec. 3, 2008.

(51) Int. Cl. B23P 19/00

(52) U.S. Cl. 29/426.1

(57) ABSTRACT

A method for removing and/or replacing tubes for generating ions in air flowing through an enclosed or partially enclosed structure. The method enables the tube to be removed and replaced without having to remove the device mounted to the structure that retains the tube.

### CROSS REFERENCE TO RELATED APPLICATIONS

This application is related to, claims priority from and hereby incorporates by reference U.S. Appl. Nos. 61/022,815, filed Jan. 22, 2008 entitled “Assembly And Housing For Duct System” and 61/119,654, filed on Dec. 3, 2008 entitled “Replacing Tubes In Air Treatment Systems.”

### FIELD OF THE INVENTION

The invention relates generally to a method and an assembly for use in a duct (such as an HVAC duct) or other enclosed or semi-enclosed space through which air flows wherein it is desirable to remove contaminants and/or odors from air using a tube to generate ions (hereafter sometimes referred to simply as a “tube”). More specifically, the invention relates to a method for removing and/or replacing tubes for generating ions in air flowing through an enclosed or partially enclosed structure. The method enables the tube to be removed and replaced without having to remove the device mounted to the structure that retains the tube.

### BACKGROUND OF THE INVENTION

Ion-generating devices, such as tubes for generating ions, are known to remove odor and/or contaminants from air. Such devices may be mounted in the central heating/ventilating/air conditioning (HVAC) system of a building—either in the air handling unit or in the main supply ductwork. Typically, ions are formed and transmitted to the air when the air passes across the tube. These ions travel through the duct system and out into the conditioned space (sometimes referred to herein as “living space” since people or animals typically use the space) attacking pollutants. Ionizing air in this fashion can remove certain airborne particles, reduce amounts of certain bacteria, mold and volatile organic compounds, and neutralize many odors.

The tubes typically degrade and become ineffective, usually after approximately a year, and thus need to be changed. Additionally, clean tubes produce more ions than dirty tubes. Particularly at a heavily-polluted commercial or industrial site (such as a manufacturing facility or waste water treatment plant) the tubes should be physically inspected and cleaned, if necessary, every 3 to 6 months. Therefore, the tubes must be capable of being accessed, removed and replaced.

Known assemblies including tubes have been metal face plates with the tube mounted to the back of the face plate. The face plate is then attached to the duct work (or other structure), usually with screws, so that the tube is positioned inside the duct in the airstream passing through the duct work. To remove and replace the tube, the face plate must be removed by removing the screws, the tube taken off the back of the face plate, a different tube replaced onto the back of the face plate and the face plate then placed back onto the duct with the tube inside the duct. To clean a tube, the face plate must still be removed and replaced, although the tube itself is not replaced.

This procedure is time consuming (since the face plate usually must be unscrewed to remove it), the duct system must usually be shut down during this procedure, and the screw holes in the duct work can be stripped when the screws are removed, requiring the face plate to be moved to a new position after the tube is replaced. This procedure is inconvenient and may cause the tube to ultimately be moved from an optimal position in the air flow to a suboptimal position when the face plate is moved. Additionally, at some point there are too many screw holes in a given area after numerous replacements and the duct must be patched with a metal plate.

Also, with this known assembly the electrical components are on the rear of the face plate and in the airstream when in use, which causes resistance and drag as air moves past and encounters the electrical components.

### SUMMARY OF THE INVENTION

The invention includes an assembly for use in a duct or other enclosed or semi-enclosed space through which air is circulated, and preferably includes (1) a housing, (2) a tube mounting member that is preferably mounted on or in the housing, or that is formed as part of the housing, and (3) a tube having an end cap that is received in the tube mounting member. The housing preferably includes a body portion defining a cavity and has a first end (or top end) and a second end (or bottom end). A partially or fully removable top cover is positioned on the first end to allow a user access to the cavity. The tube mounting member is preferably positioned in the cavity and can have a portion to support the end of the tube that extends through the second end of the housing and into the air flow of the enclosed space when the assembly is mounted. The tube mounting member also preferably includes a tube mounting collar and has an opening therethrough through which the tube can fit. In the preferred embodiment, the tube mounting collar includes a groove and openings therein.

The tube preferably is capable of producing ions that pass into air as the air flows past the tube. The tube has an end cap, preferably with projections that are received in the openings in the tube mounting collar. Once received in the openings, the tube is twisted to move the projections into the groove thereby retaining the end cap in the groove and the tube in the tube mounting member.

In operation, the housing is attached to the structure defining the space through which air flows and the tube mounting member is positioned at least partially in the cavity of the housing with the (optional) tube support section extending through the second end of the housing and into the space where air flows. The tube is positioned into the tube mounting member by moving it through the first end of the housing, through the cavity and through the opening in the tube mounting member, so the tube extends into the space where air flows. The projections in the tube end cap are received in the openings in the groove of the tube retention collar and the tube is then turned so the projections are retained in the groove thus securing the tube in place. The top cover of the housing is then put into place to cover the cavity.

Using an assembly according to the invention, the tube can be replaced more quickly since the housing is never removed from the duct or other structure through which the air moves. The present invention also eliminates the need to compensate for screw holes being stripped when the face plate is removed and replaced, as previously described. It has the further benefit of maintaining electrical components on the inside of the housing, which reduces drag.

While this is a summary of a preferred embodiment, any structures that enable the tube to be removed and/or replaced without detaching a structure from the duct or other structure through which air flows and into which a tube is placed may be used.

Also disclosed is a tool that may be used to install or remove a tube according to the invention.

### BRIEF DESCRIPTION OF THE DRAWINGS

FIG. 1 is a perspective, side view of an assembly according to the invention.

FIG. 2 is a side, rear view of the assembly of FIG. 1.

FIG. 3 is a side, front view of the assembly of FIG. 1.

FIG. 4 is a perspective, side view of the assembly of FIG. 1 with the top cover removed.

FIG. 5 is a perspective, top view of the assembly of FIG. 4.

FIG. 6 is a perspective, side view of a tube mounting member in accordance with the invention.

FIG. 7 is a perspective view of the tube mounting member of FIG. 6 without the mounting collar attached.

FIG. 7A is a top view of the mounting structure of FIG. 7.

FIG. 7B is a cross-sectional view taken along lines A-A of FIG. 7A.

FIG. 7C is a side view of the tube mounting member of FIG. 7A.

FIG. 7D is a bottom view of the tube mounting member of FIG. 7A.

FIG. 7E is a side view of the tube mounting member of FIG. 7D.

FIG. 8 is a perspective top view of a mounting collar used with the tube mounting member of FIGS. 6-7E.

FIG. 8A is a top view of the mounting collar of FIG. 8.

FIG. 8B is a cross-sectional view taken along lines A-A of FIG. 8A.

FIG. 8C is a cross-sectional view taken along lines B-B of FIG. 8A.

FIG. 9 is an exploded view of the tube mounting member of FIG. 6.

FIG. 10 is an exploded view of one preferred embodiment of a tube that can be used with the invention.

FIG. 11 is a perspective, bottom view of an end cap that can be used with tube 200.

FIG. 11A is a top view of the end cap of FIG. 11.

FIG. 11B is a cross-sectional view taken along lines A-A of FIG. 11A.

FIG. 11C is a side view of the end cap of FIG. 11A.

FIG. 11D is a partial, enlarged view of the groove in the top of the end cap shown in FIG. 11A and as shown in area C.

FIG. 11E is a bottom view of the end cap shown in FIG. 11.

FIG. 11F is a partial, enlarged view of a projection on the end cap as shown in FIG. 11C, as shown in area B.

FIG. 12 is a perspective, top view of a tool used with an end cap according to the invention.

FIG. 13 is a perspective, bottom view of the tool of FIG. 12.

### DETAILED DESCRIPTION

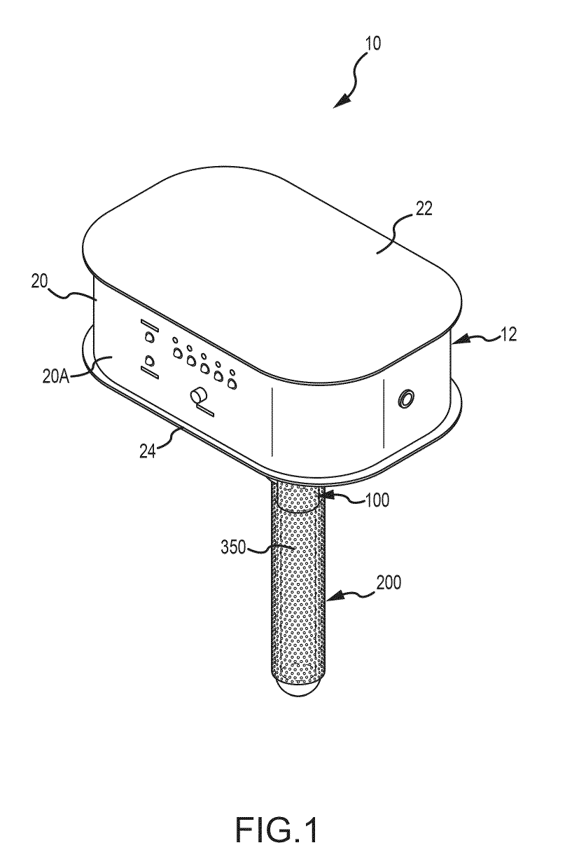

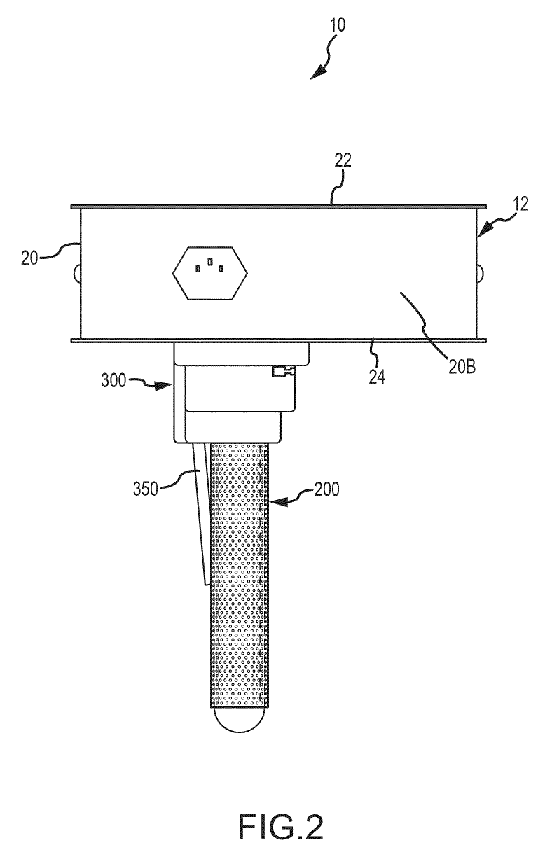

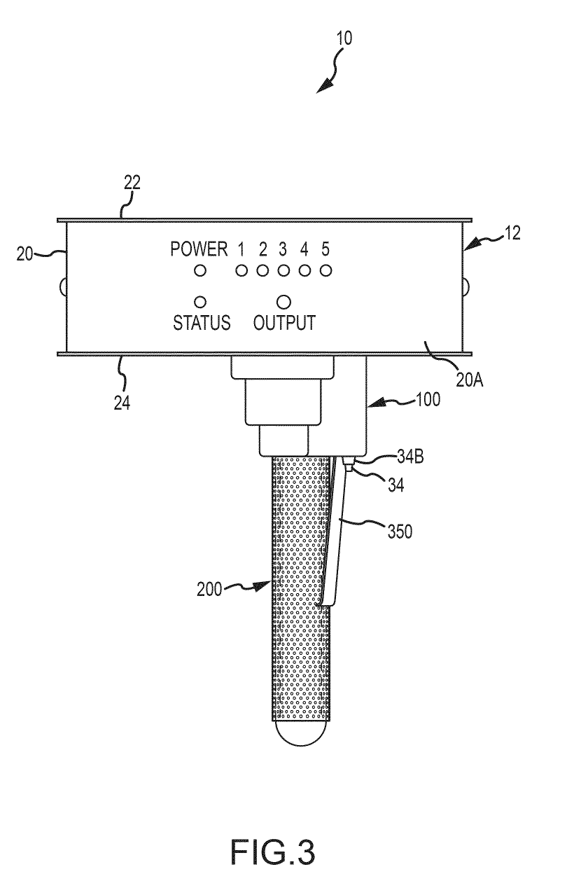

Turning now to the drawings, where the purpose is to describe preferred embodiments of the invention and not to limit same, FIG. 1 shows a housing 10, a tube holder 100 and a tube 200.

Device 10 has a housing 12, which includes a tube mounting member 100 when fully assembled. Device 10, among other things, retains and supplies electricity to a tube 200, which generates ions that pass into the air or other gas around tube 200.

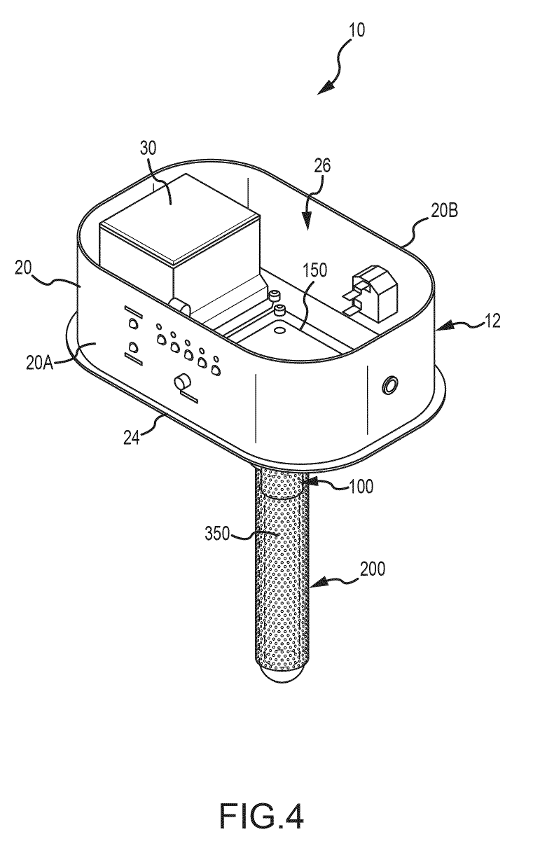

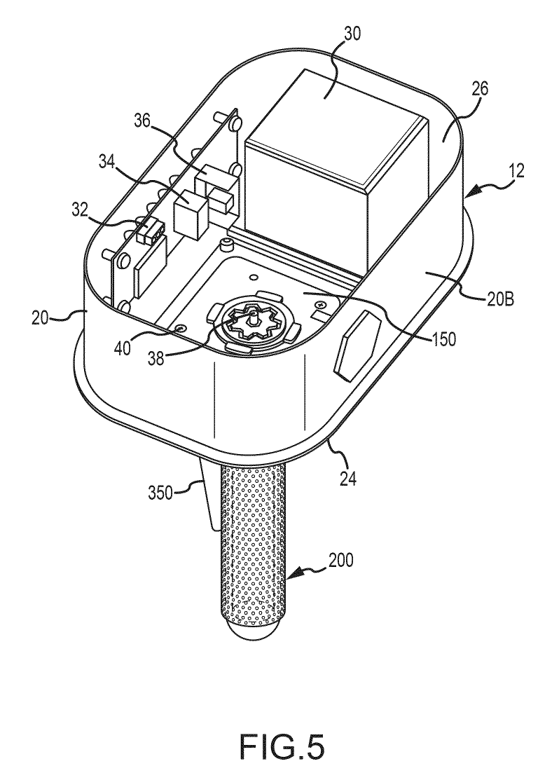

Housing 12 has a body portion 20 that defines a cavity 26, a first end having a top cover 22 that is at least partially removable and a second end having a bottom surface 24. In this embodiment top cover 22 is fully removable, and as can be seen in FIGS. 4 and 5, when it is removed it exposes and provides access to cavity 26. Body portion 20 may be comprised of any suitable material, such as plastic or metal, and may be of any suitable size and shape. Preferably body portion 20 of housing 12 is formed of steel, and is generally rectangular with rounded edges. Housing 12 is preferably about 10-14″ long (most preferably about 12″), about 5-8″ wide (most preferably about 6″) and about 4-5″ in depth (most preferably about 4″), but as previously mentioned, can be of any suitable size or shape.

Top cover 22 is preferably a removable, steel plate that entirely covers the first end of housing 10 thereby completely covering cavity 26. Top cover 22 may be any suitable material and have any suitable size or shape to enable a user to remove all or part of top cover 22 to access cavity 26 and tube 200. Top cover 22 may be screwed to body portion 20, hinged thereto, or may comprise a sliding panel that can be opened and closed. Further, in any embodiment only part of top cover 22 need be opened or removed to allow access to cavity 26 and tube 200. As used herein, when reference is made to opening or removing top cover 22, unless expressly stated to the contrary, this means opening or removing all or part of top cover 22 to allow access to tube 200 to permit removal and/or replacement of tube 200.

Positioned inside of cavity 26 are electric components for the operation of tube 200, and these components are known to those skilled in the art. As generally shown in FIGS. 4 and 5, these components include a transformer 30 (which is preferably used to increase the voltage from about 110V to 3,000V), a connector 32 that connects the external electrical supply to the components in the assembly, a filter capacitor 34 and relay 36. Connectors (not shown) go from transformer 30 to lead 38 (which ultimately connects to the metal mesh inside of tube 200 and transfers a charge to that mesh) and to screw 40, which is attached to ground stop 350 which is pressed against the metal mesh on the outside of tube 200 and ultimately transfers a charge to that mesh. Also included in cavity 26 is part of tube mounting member 100, which in this embodiment has a portion that extends through bottom surface 24.

Housing 12 has a first side 20A and a second side 20B. First side 28A includes controls and side 20B includes a plug (to receive external power) and a fuse, which is preferably a one amp fuse. The controls, known to those in the relevant art, include a push button or rotating switch to increase or decrease the amount of power to the tube, a fault light to indicate when the tube is malfunctioning, a power “on” indicator, and indicators to inform a user the power level at which the tube is functioning.

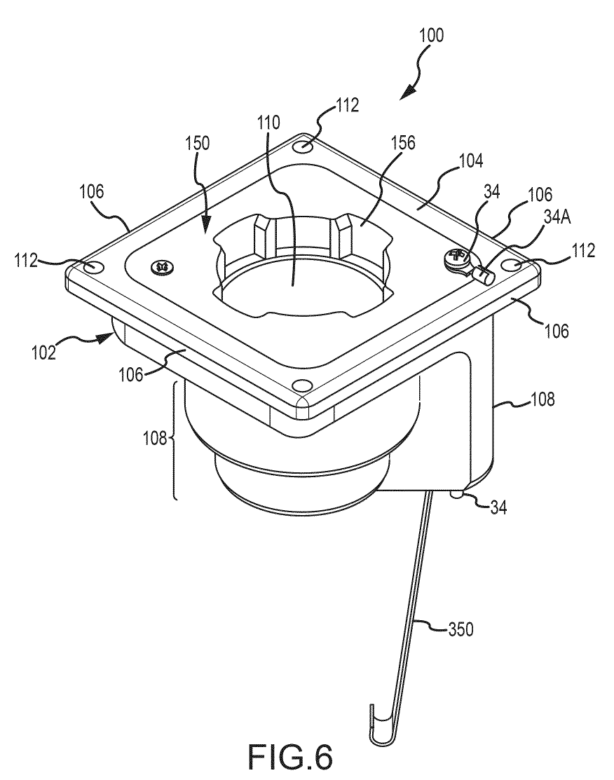

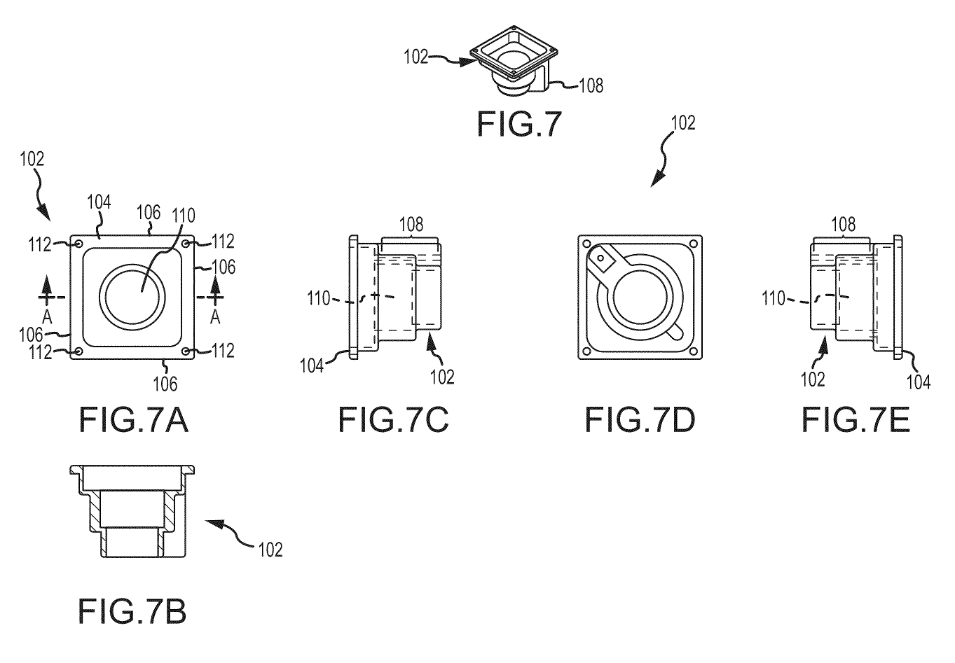

Tube mounting member 100 is shown, among other places, in FIGS. 6-9. Tube mounting member 100 is preferably comprised of plastic (most preferably ABS) although any suitable material may be used. Tube mounting member 100 may also be of any suitable shape or configuration that enables the tube to be (1) retained while in use, and (2) removed and installed without having to remove housing 12 after it is mounted to the structure (such as a duct) through which air flows.

As shown, tube mounting member 100 has a body portion 102 and a collar 150 (best seen in FIGS. 6 and 8 through 9) although the tube mounting member could be integrally formed. Further, the tube mounting member could be formed as part of housing 12, rather than being a separate piece preferably attached to and used with housing 12.

Body 102 has a top end 104, four sides 106, a pillar portion 108, an optional tube support region 108 and an opening 110 therethrough to enable tube 200 to pass through tube mounting member 100 and be retained at least partially inside of the structure through which air flows in order to transfer ions to the air. Body 102 also has four apertures 112 to enable body 102 to be secured to housing 12.

Pillar portion 108 is used to support ground stop 350, which supplies an electrical charge to the outside mesh of tube 200. Screw 40 passes through pillar portion 108 and has a lead 34A that connects to transformer 30, and is secured to ground stop 350 by a bolt 34B.

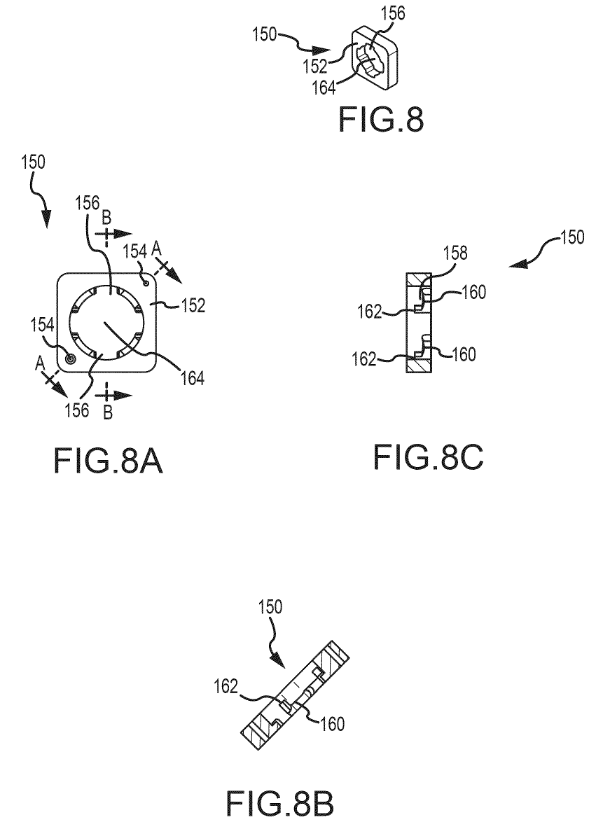

Collar 150 has a top 152 with two apertures 154, four openings 156, and an internal channel 158. Collar 150 is preferably made of plastic (most preferably ABS) although any suitable material may be used, and collar 150 may be of any suitable size or configuration. As shown in FIGS. 6 and 8A-8C, collar 150 preferably has four openings 156 to align with and receive corresponding projections on the end cap of tube 200, but may include any number of openings (as few as one) capable of properly retaining tube 200. In this embodiment, within the channel 158 adjacent each opening 156 is a detent 160 configured to receive and retain a projection of the end cap, wherein the projection can still be released from the detent upon the application of sufficient force. In this embodiment each detent 160 has a rounded top end to receive rounded ends of the corresponding projections on the end cap, although other suitable configurations could be used.

In this embodiment, each detent has a stop 162 formed on its trailing side to prevent a user form overtightening a tube 200 and to provide tactile feedback to inform a user when the tube is securely mounted. Collar 150 also has an opening 164 that is large enough to allow for the passage of tube 200 but not end cap 250, therethrough.

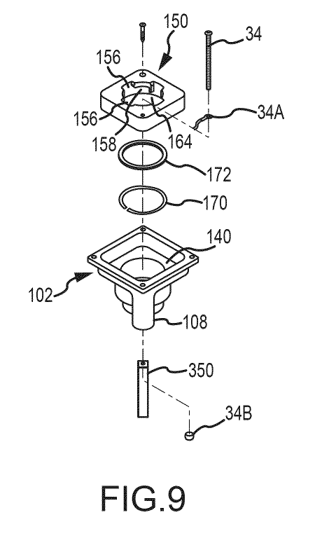

FIG. 9 shows an exploded view of tube mounting assembly 100 and components that are attached or used in conjunction with it. One optional feature is the use of a pressure-generating device to essentially “spring load” the end cap and tube into the tube mounting member. In this embodiment a wave washer 170 is used to generate the pressure against end cap 250. Wave washer is positioned on surface 140 of body 102 and preferably a standard washer 172 is placed over it. When collar 150 is attached to body 102 the washers are retained in a compartment between collar 150 and body 102 and are compressed when end 250 is mounted in channel 158.

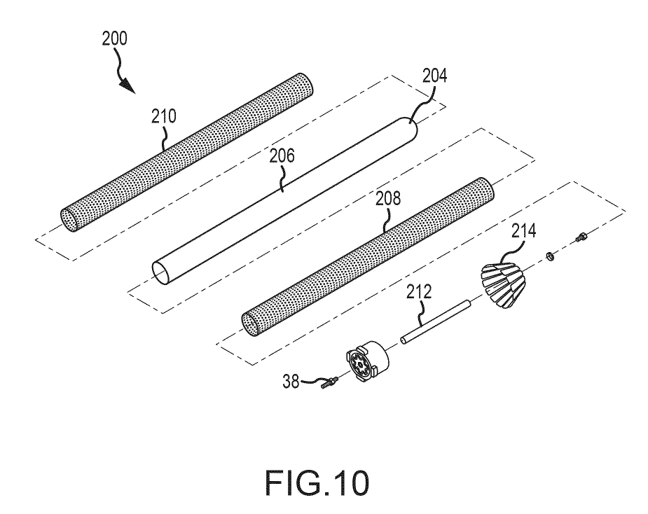

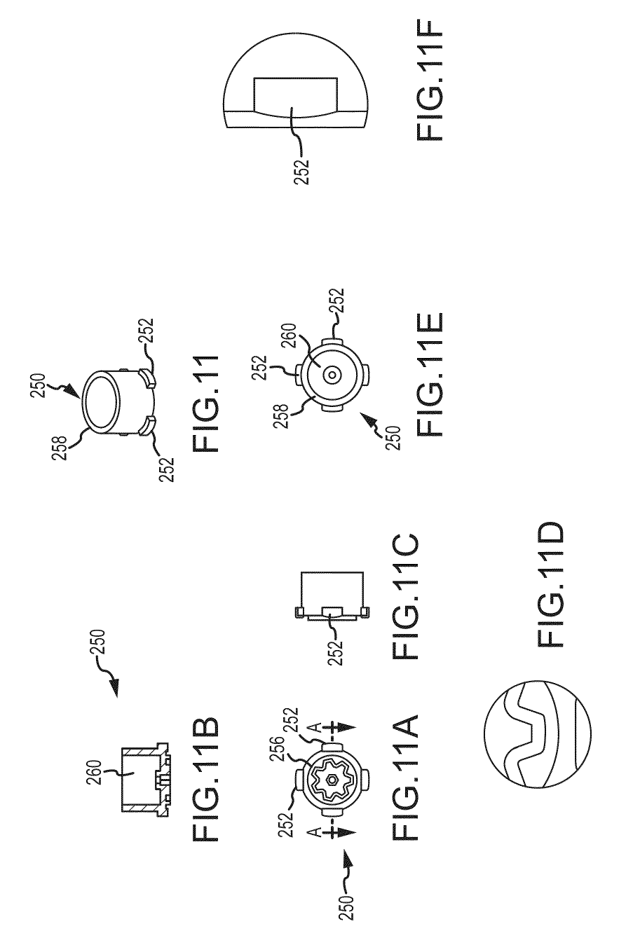

FIG. 10 shows a tube 200 known in the art for generating ions. Tube 200 has a first end 202, a second end 204, comprises a glass tube 206, an inner mesh 208 that is positioned inside of tube 206 and an outer mesh 210 that is positioned outside of tube 206. Tube 202 may be of any suitable shape and size and as shown is cylindrical, between 1″ and 2″ in diameter (preferably about 1¾″) and between about 250 mm and 550 mm in length. Inner mesh 208 is preferably an aluminum/platinum alloy and outer mesh 210 is preferably steel.

Positioned inside of inner mesh 208 is a spacer 212 and an electrical conductor 214. Spacer 212 is preferably about 5″ long and conductor 214 contacts inner mesh 208. Screw 38 is connected to transformer 30 and transfers an electric charge to spacer 212, to conductor 214 and into mesh 208. As previously described, ground stop 350 transfers electrical current into outer mesh 210.

End cap 250 is attached to end 202 preferably by use of a silicone sealant. End cap 250 has at least one projection 252, and as shown has four projections 252, a body portion 254, a top surface 256, a bottom surface 258 and an opening 260 for receiving end 202 of glass tube 206. End cap 250 is preferably comprised of plastic and most preferably ABS, but can be made of any suitable material. As shown, each projection 252 on end cap 250 has a slightly rounded top to be received in previously-described detents 160 in channel 158. End cap 250 also has a groove 260 that mates with mounting tool 300, described below.

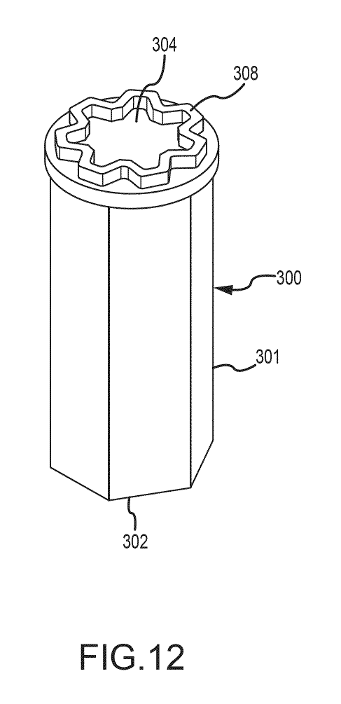

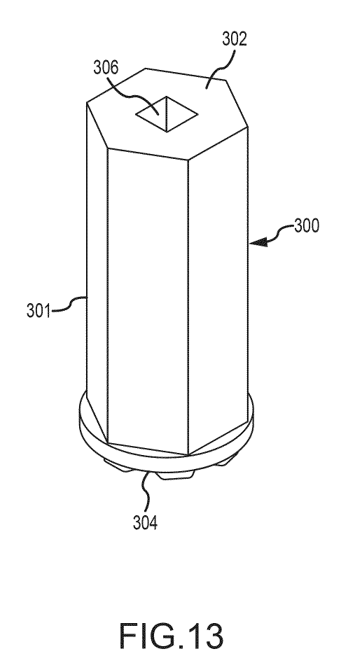

Tool 300 is shown in FIGS. 12 and 13. Tool 300 is comprised of any material and can be of any suitable size, material and configuration to remove and/or replace tube 200. As shown tool 300 is preferably comprised of steel and has a body 301, a first end 302 and a second end 304.

Body 301 is hexagonal so it can be engaged by a wrench and end 302 has a rectangular opening designed to engage a standard Allen Wrench. End 304 has a projecting surface 308 that engages the groove in end cap 250.

Utilizing the invention, a tube may be replaced without removing a device attached to a structure (particularly an HVAC duct) through which air flows. The tube is simply (a) accessed and removed, (b) then replaced by reinserting a different tube through the opening in the tube support member so the tube extends into the structure where it can place ions into the air, and (c) then securing end cap 250 and tube 200 utilizing the tube support member.

Other embodiments of the invention will be apparent to those skilled in the art from consideration of the specification and embodiments disclosed herein. Thus, the specification and examples are exemplary only, with the true scope and spirit of the invention set forth in the following claims and legal equivalents thereof.

What is claimed is:

1. A method for removing a tube for generating ions from a structure that has an interior portion with air flowing through it, and that is enclosed or partially enclosed from living space, wherein the tube is retained by a device that is attached to the structure, the tube being removed without detaching the device from the structure.

2. The method of claim 1 wherein the device is a tube mounting member.

3. The method of claim 1 wherein the device is an assembly including a housing that comprises a tube mounting member.

4. The method of claim 1 wherein the tube has an end cap that is retained in the device outside of the interior portion of the structure.

5. The method of claim 1 wherein the structure is totally enclosed.

6. The method of claim 5 wherein the structure is a duct.

7. The method of claim 3 wherein the housing is attached to the structure and the tube mounting member is attached to the housing and the housing is not detached from the structure during removal of the tube.

8. The method of claim 7 wherein neither the housing nor the tube mounting member are detached during removal of the tube.

9. The method of claim 3 wherein the tube mounting member is one or more separate components attached to the housing.

10. The method of claim 3 wherein the tube mounting member includes a channel having one or more openings and the tube has an end cap with one or more projections, wherein the projections are received in the openings and the tube is turned to move the projections into the channel thereby retaining the tube.

11. The method of claim 10 wherein the projections have pressure applied to them when in the channel.

12. The method of claim 10 wherein the end cap further includes a groove that mates with a tool and further includes the step of turning the end cap and the tube with the tool to secure it into place or remove it.

13. The method of claim 1 that further includes the step of replacing the removed tube with a different tube.

14. The method of claim 13 wherein the device has an opening through which at least part of the tube can pass and be positioned in the interior portion.

15. The method of claim 3 wherein the device has an opening through which at least part of the tube can pass and be positioned in the interior portion, the opening being in the tube mounting member.

16. The method of claim 15 wherein the tube has an end cap that is retained by the tube mounting member.

17. The method of claim 16 wherein the end cap has one or more projections and the tube mounting member has a channel with one or more openings, the projections being received in the openings and moving into the channel when the tube is turned.

18. The method of claim 17 wherein there is a detent adjacent each of the openings and each of the detents is configured to receive the projection.

19. The method of claim 18 wherein there is a stop on the trailing edge of each detent.

20. The method of claim 18 wherein each detent has a rounded surface configured to receive the rounded surface of the projection.

21. The method of claim 11 wherein the pressure is applied by a wave washer.

22. The method of claim 11 wherein the pressure is between 10-15 lbs.
